(19) United States
(12) Patent Application Publication
(10) Pub. No.: US 2023/0058817 A1
(43) Pub. Date: Feb. 23, 2023

(54) STRUCTURE FOR UTILIZING INDOOR NATURAL LIGHT IN MOVING SPACE AND METHOD THEREFORE

(71) Applicants: HYUNDAI MOTOR COMPANY, Seoul (JP); KIA CORPORATION, Seoul (JP)

(72) Inventors: Soon Sung Park, Seoul (KR); Se Hoon Kim, Seongnam-si (KR); Ki Sung Kim, Suwon-si (KR)

(21) Appl. No.: 17/888,130

(22) Filed: Aug. 15, 2022

(30) Foreign Application Priority Data
Aug. 19, 2021 (KR) 10-2021-0109231

(51) Int. Cl. B60J 3/04

(52) U.S. Cl. CPC B60J 3/04

(57) ABSTRACT

A structure for utilizing indoor natural light in a moving space includes a smart light blocking unit located on a vehicle and configured such that transmittance of at least a portion thereof is able to be controlled, an indoor camera configured to measure an indoor environment of the vehicle, a receiver configured to receive a user's request, and a controller configured to determine an indoor state of the vehicle using the indoor camera and to set a light blocking area of the smart light blocking unit by receiving the user's request through the receiver.

### CROSS REFERENCE TO RELATED APPLICATIONS

The present application claims priority to Korean Patent Application No. 10-2021-0109231, filed Aug. 19, 2021, the entire contents of which is incorporated herein for all purposes by this reference.

### BACKGROUND

### Field

The present disclosure relates generally to a structure for utilizing indoor natural light in a moving space and a method therefore and, more particularly, to a structure for utilizing indoor natural light in a moving space and a method therefore for controlling light to be a lighting state suitable for a future multi-purpose indoor space use through a controller and, at the same time, for performing blocking of a light source that is introduced from the outside as natural light.

### Description of the Related Art

Generally, a lighting device is installed in a vehicle interior so as to illuminate the vehicle interior. A vehicle interior lighting device is typically configured to include front interior lamps, central interior lamps, and reading lamps. Conventionally, fluorescent lamps or Light Emitting Diodes (LEDs) emitting monochromatic light are applied as interior lighting of a vehicle.

As described above, the light emitted from the lighting of the conventional vehicle interior lighting device is artificial monochromatic light, which can easily tire the eyes of the occupant. Accordingly, various lighting environments are set up to create a more human-centered natural lighting change even in the vehicle interior, and various lighting devices capable of selectively controlling brightness to provide such a lighting environment have been developed. For example, a dimming function is used to selectively adjust the brightness of lighting. However, only the brightness may be adjusted, a change in natural light is unable to be produced, and the lighting may not be adjusted according to various indoor situations.

In recent years, for the convenience of a user using a vehicle, there is a trend that various sensors and electronic devices are being provided. In particular, research on an advanced driver assistance system (ADAS) is being actively conducted for a user's driving convenience. Furthermore, the development of autonomous vehicles is being actively pursued.

In addition, “Purpose Built Vehicle (hereinafter referred to PBV)” is emerging as a future mobility that extends living space. For example, when a PBV composed of a shoe store and a clothing store is docked to a hub, the hub becomes a shopping center. The possibility of function and design expansion according to the purpose of PBV is quite large. The PBV is a new form of mobility, which is neither public transportation like a bus nor a personal car, and is used as a flexible space such that the purpose of the hub itself changes depending on the purpose of the PBV docked to the hub.

For higher utilization of such autonomous vehicles or PBVs, there is a need for an efficient lighting system suitable for a situation when used for personal use or a service industry. For example, in situations such as rest, daily life, indoor plant cultivation, and the like, it is necessary to use natural light as much as possible, and in a situation to sleep, watch a movie, or to change an atmosphere, it is necessary to adjust the lighting by using artificial light.

Accordingly, in the case of a vehicle to which natural light is introduced, a light-shielding/light blocking area is essential, and through the light-shielding area, it is necessary to improve the driving environment.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose a structure for utilizing indoor natural light in a moving space and a method therefore, which are capable of controlling a light blocking area according to a user's request signal through a controller.

In addition, there is provided a structure for utilizing indoor natural light in a moving space, the structure being configured to determine the natural light that is introduced and to allow the natural light that is introduced to be illuminated only to a predetermined area in the vehicle interior.

The objectives of the present disclosure are not limited to the objectives mentioned above, and other objectives of the present disclosure not mentioned may be understood by the following description, and may be seen more clearly by examples of the present disclosure.

In order to achieve the above objectives, according to one aspect of the present disclosure, there may be provided a structure for utilizing indoor natural light in a moving space, the structure including a smart light blocking unit located on a vehicle and configured such that transmittance of at least a portion thereof is able to be controlled, an indoor camera configured to measure an indoor environment of the vehicle, a receiver configured to receive a user's request, and a controller configured to determine an indoor state of the vehicle using the indoor camera and to set a light blocking area of the smart light blocking unit by receiving the user's request through the receiver.

In addition, the controller may be configured to control the transmittance of at least a portion of the smart light blocking unit to form the requested light blocking area according to a position of an external light source received from the controller.

In addition, the controller may be configured to determine a position of a driver received from the indoor camera and to control the transmittance of the smart light blocking unit to set the light blocking area in an area corresponding to the driver's view.

In addition, the smart light blocking unit may be configured to be positioned in a roof area.

In addition, the structure may further include a lighting device configured to illuminate light into a vehicle interior.

In addition, the controller may be configured such that, when the indoor camera determines the indoor environment of the vehicle, and when the indoor illuminance of the vehicle is no greater than a reference value, the controller may drive the lighting device.

In addition, the controller may be configured to compensate a position of the light blocking area according to a driving state of the vehicle and a positional relation of the light source.

In addition, there may be provided a method for utilizing indoor natural light in a moving space, the method including determining whether current indoor information checking is possible, when it is determined that the current indoor information checking is possible, determining, by a controller, whether current indoor information and a user's request signal match with each other, when the current indoor information and the user's request signal do not match with each other, setting, by the controller, a light blocking area of a smart light blocking unit, and adjusting, by the controller, a position value of the light blocking area of the smart light blocking unit.

In addition, the determining whether the current indoor information checking is possible may include determining, by the camera unit, whether indoor information detection is possible, when it is determined that the detection is not possible, operating a lighting device so that the camera unit may detect the indoor information, and when it is determined that the detection is possible, analyzing the current indoor information, receiving the user's request signal, and analyzing a lighting environment optimized for the current indoor information, by the controller.

In addition, the setting, by the controller, a light blocking area of a smart light blocking unit may include measuring incoming natural light, and when the incoming natural light is no less than a set value, determining the light blocking area of the smart light blocking unit.

In addition, the adjusting, by the controller, a position value of the light blocking area of the smart light blocking unit may include determining, by the controller, whether the light blocking area is formed on a position value according to the user's request signal, and when the light blocking area is not formed on the position value according to the user's request signal, transmitting, by the controller, a movement signal of the smart light blocking unit so that the light blocking area is formed on the position value according to the user's request signal.

As described above, the present disclosure can obtain the following effects by the present embodiment seen above and the configuration, combination, and use relationship described below.

It is possible to control a lighting state appropriate to a user's request signal through a controller so that there is the effect of providing various customized services to users in autonomous vehicles and PBVs.

In addition, a light blocking area can be selectively provided in the vehicle interior in response to a user's request, thereby providing an improvement in the boarding environment of the vehicle.

### BRIEF DESCRIPTION OF THE FIGURES

The above and other objectives, features, and other advantages of the present disclosure will be more clearly understood from the following detailed description when taken in conjunction with the accompanying drawings, in which:

FIG. 1 is a configuration diagram illustrating a structure for utilizing indoor natural light in a moving space as an embodiment of the present disclosure;

FIG. 2 is a block diagram illustrating the structure for utilizing indoor natural light in a moving space as the embodiment of the present disclosure;

FIG. 3 is a view illustrating a light blocking area formed according to a light source with the structure for utilizing indoor natural light in a moving space as the embodiment of the present disclosure;

FIG. 4 is a view illustrating a light blocking area formed in response to a user's request with the structure for utilizing indoor natural light in a moving space as the embodiment of the present disclosure;

FIG. 5 is a flowchart illustrating a method for utilizing indoor natural light in a moving space as the embodiment of the present disclosure;

FIG. 6 is a flowchart illustrating determining whether or not a current indoor information checking is possible in the method for utilizing indoor natural light in a moving space as the embodiment of the present disclosure; and

FIG. 7 is a flowchart illustrating adjusting a position value of the light blocking area of a smart light blocking unit in the method for utilizing indoor natural light in a moving space as the embodiment of the present disclosure.

### DETAILED DESCRIPTION

Hereinbelow, embodiments of the present disclosure will be described in more detail with reference to the accompanying drawings. The embodiments of the present disclosure may be modified in various forms, and the scope of the present disclosure should not be construed as being limited to the following embodiments. The present embodiment is provided to more completely explain the present disclosure to those of ordinary skill in the art.

In addition, terms such as “ . . . unit”, “ . . . device”, and the like described in the specification mean a unit that processes at least one function or operation, and the unit may be implemented as a combination of hardware.

In addition, in each of steps, an identification code is used for convenience of description, but the identification code does not describe an order of each of the steps. Accordingly, each of the steps may be performed differently from the specified order unless a specific order is clearly stated in the context.

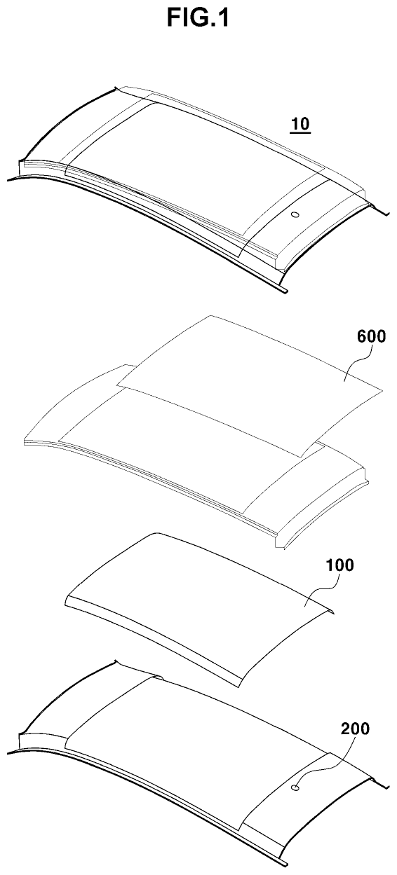

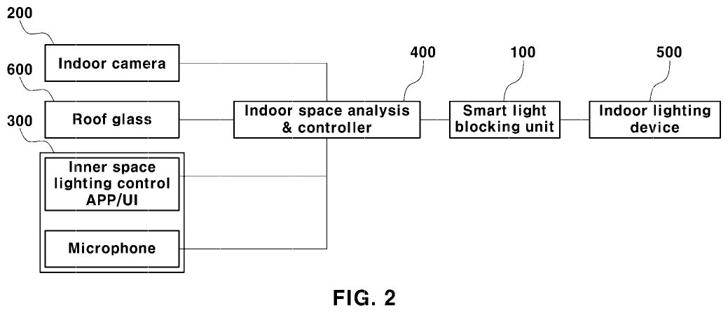

FIGS. 1 to 2 are views illustrating a configuration of a structure 10 for utilizing indoor natural light in a moving space as an embodiment of the present disclosure.

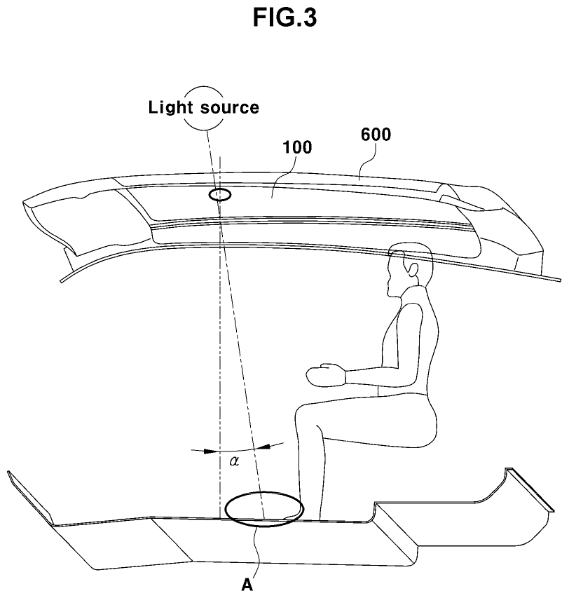

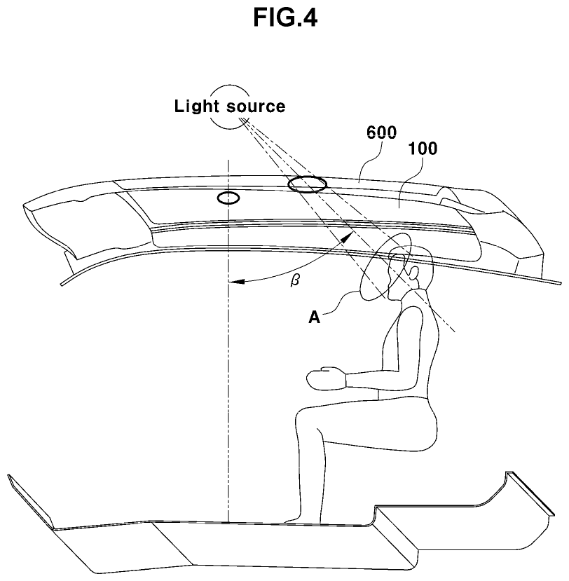

As illustrated, the present disclosure provides a structure configured to form a light blocking area “A” (shown in FIGS. 3 and 4) through a smart light blocking unit 100 in response to light that is introduced into a vehicle interior from a light source located outside the vehicle.

The smart light blocking unit 100 may be configured such that transparency of at least a portion of the smart light blocking unit 100 is controlled by a controller 400 so that light illuminated from an external light source is not transmitted into the vehicle interior. In addition, the smart light blocking unit 100 may be located on a vehicle roof and is made of smart glass, thereby allowing a transmittance of a predetermined area to be varied according to the application of current.

An indoor camera 200 is configured to be able to determine an illuminance value inside the vehicle and to determine whether the light blocking area “A” has been formed in response to a user's request. Moreover, the indoor camera 200 is configured to perform first current indoor information checking of the vehicle.

A receiver 300 may be configured to receive a user's input and thus to transmit the received user's request to the controller 400. In addition, the receiver 300 of the present disclosure may be composed of a microphone, a switch, and the like, and the receiver 300 may be configured to be able to select a size and position of the light blocking area “A”, and the transmittance of light entering the light blocking area “A”.

The controller 400 is configured to be able to store the indoor information of the vehicle received through the indoor camera 200, to store a position value of the external light source through an illuminance sensor and the like located in the vehicle, and to receive data about the driving speed and current location of the vehicle.

Furthermore, the controller 400 may determine an amount of illuminance in the vehicle interior for receiving the indoor information of the vehicle through the indoor camera 200 and, when the amount of the measured illuminance is determined that the current indoor information checking is not possible (no greater than the reference value), may control to apply power to the lighting device 500 located in the vehicle. Accordingly, the controller 400 is configured to be able to receive first vehicle interior information and to set the light blocking area “A” on the basis of the received information. Moreover, the controller 400 may not only control the position of the light blocking for performing natural light blocking but also control the indoor illumination of the vehicle to be maintained at no less than a reference value through the lighting device 500. That is, the controller 400 is able to control the natural light blocking area and the intensity of the light of the lighting device and, thus, may perform integrated control in consideration of the illuminance value of the vehicle interior.

In addition, the controller 400 is able to receive information of a height direction angle and a horizontal direction position of the light source through an illuminance sensor located at a front end of the vehicle in order to measure a position of the external light source.

Moreover, the controller 400 is configured to control the smart light blocking unit on the basis of location information of the light source. In addition, the controller 400 may be configured to control the transmittance and a refractive index of the smart light blocking unit 100 to block at least a portion of the light introduced through the smart light blocking unit 100.

In addition, the controller 400 is configured to control the transmittance of at least one area of the smart light blocking unit 100 so that the light blocking area “A” is formed in response to a user's request received through the receiver 300, so as to reduce the amount of light flowing/introduced into the vehicle interior. As the embodiment of the present disclosure, the light blocking area “A” may be configured to be formed in an area adjacent to a user's view.

The light blocking area “A” is formed according to the area where the transmittance of the smart light blocking unit 100 is reduced, and is an area in which the transmittance is relatively reduced compared to other areas of the glass, and the transmittance may be variably set in response to the user's request.

FIG. 3 illustrates an area on which light illuminated from an external light source is blocked by the smart light blocking unit 100, and FIG. 4 illustrates the smart light blocking unit 100 configured to form the light blocking area “A” in response to the user's request.

As shown in FIG. 3, the smart light blocking unit 100 is a structure for utilizing indoor natural light in a moving space and is configured to be located at a bottom end of a glass 600 of the roof. Here, the smart light blocking unit 100 is configured to control the transmittance of at least a portion of the smart light blocking unit 100 so as to form the indoor light blocking area “A” of the vehicle by being coupled with the controller 400. In addition, the smart light blocking unit 100 is configured so that the current is applied to at least a portion of the smart light blocking unit 100 so as to form the light blocking area A, and the area, of the smart light blocking unit 100, to which the current is applied, varies in order to allow the transmittance to be lowered. Accordingly, a transmittance variable region of the smart light blocking unit 100, the region forming the light blocking area “A”, is controlled to transmit a relatively low amount of light compared with the amount of light naturally transmitted through the roof glass 600.

In addition, the controller 400 may calculate a height and vertical and horizontal angles, which are formed with the vehicle, of the light source and, through this, may calculate an illumination angle of the light entering the vehicle. The light blocking area “A” formed on a floor of the vehicle in a state where an angle of inflow into the vehicle is “a” is included in FIG. 3.

Moreover, in response to the user's request received through the receiver 300, the light blocking area “A” can be variable, so that the transmittance variable region of the smart light blocking unit 100 whose transmittance is variable through the controller 400 may be set. Alternatively, the refractive index of the smart light blocking unit 100 may be controlled so that light flowing into the smart light blocking unit 100 is refracted.

In FIG. 4, the structure 10 for utilizing indoor natural light in a moving space, in which a light blocking area “A” is formed in a user's viewing range, is provided as the embodiment of the present disclosure. That is, the transmittance variable region of the smart light blocking unit 100 is set so that light incident from the light source is incident at an angle “b” with a vertical direction of the smart light blocking unit 100 as a reference, so the structure for utilizing indoor natural light in a moving space is configured such that the light blocking area is formed at a position corresponding to the user's viewing range.

In the meanwhile, the controller 400 may move the transmittance variable region formed in the smart light blocking unit 100 in response to a movement of the vehicle.

In this way, the controller 400 of the structure 10 for utilizing indoor natural light in a moving space of the present disclosure receives the indoor information of the vehicle and is configured to control the refractive index and/or transmittance of the smart light blocking unit 100 on the basis of the user's request received from the receiver 300. That is, the controller 400 is configured to provide the light blocking area “A” formed in a predetermined space inside the vehicle interior.

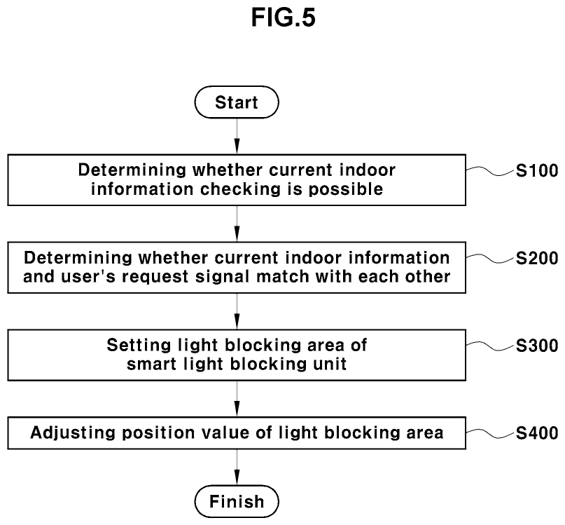

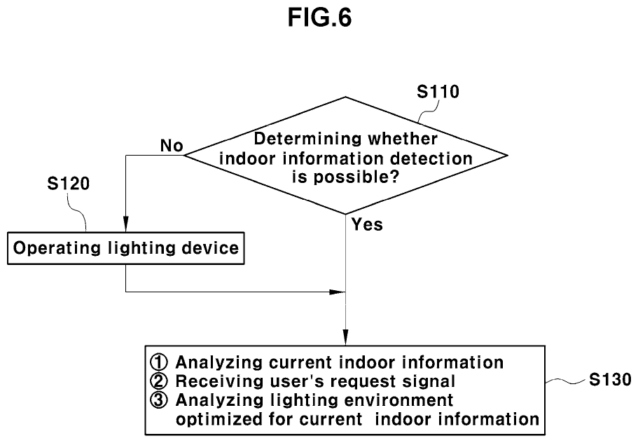

FIG. 5 is a flowchart illustrating a method for utilizing indoor natural light in a moving space as the embodiment of the present disclosure, and FIG. 6 is a flowchart illustrating determining whether or not current indoor information checking is possible in the method for utilizing indoor natural light in a moving space as the embodiment of the present disclosure.

With reference to FIGS. 5 and 6, the method for utilizing indoor natural light in a moving space according to an embodiment of the present disclosure may include determining whether current indoor information checking is possible at S100. When it is determined checking is possible, a controller 400 determines whether current indoor information and a user's request signal match with each other at S200. When the current indoor information and the user's request signal do not match with each other, the controller 400 sets a light blocking area “A” of a smart light blocking unit 100 at S300. Then, the controller 400 adjusts a position value of the light blocking area “A” of the smart light blocking unit 100 at S400.

The determining whether the current indoor information checking is possible in S100 may include determining, by the camera unit 600, whether indoor information detection is possible, when it is determined that the detection is not possible, operating the lighting device 500 so that the camera unit 600 may detect the indoor information, and when it is determined that the detection is possible, analyzing the current indoor information, receiving the user's request signal, and analyzing a lighting environment optimized for the current indoor information, by the controller 400.

The determining, by the camera unit 600, whether the indoor information detection is possible may be determining whether indoor brightness is to the extent that a type or location of an object or a user is to be sufficiently detected at S110. When the indoor information detection is impossible, operating the lighting device 500 to a degree that the indoor information detection may be possible at S120 may be performed by the controller 400. When it is a state in which the camera unit 600 is capable of performing the indoor information detection, analyzing the current indoor information detected by the camera unit 600 at S130 may be performed by the controller 400. The current indoor information may be information of an indoor user or object, of the current vehicle. In addition, at S100, the controller 400 may receive the user's request signal. For example, receiving the user's request signal may be performed by the controller 400 through an application of a user's mobile phone or a voice recognition unit installed in the vehicle at S130.

At the same time, analyzing the lighting environment optimized for the current indoor information may be performed by the controller 400 at S130. For example, the controller 400 may analyze a recommended light blocking environment optimized for GPS or time information, of the current vehicle. At the same time, the controller 400 may measure the indoor illuminance value of the vehicle in real time in the setting a light blocking area and is configured, when the measured illuminance value is no greater than the set value, such that additional illuminance is able to be applied to the vehicle interior through the lighting device.

When it is determined the checking is possible in the determining whether a current indoor information checking is possible, the determining, by the controller 400, whether the current indoor information and the user's request signal match with each other may be performed. The determining whether the current indoor information and the user's request signal match with each other by the controller 400 may be characterized in that the controller 400 determines whether the result value of analyzing the current indoor information matches the user's request signal and the light blocking environment optimized for the current indoor information.

The user's request signal may be a request signal input from a device such as a user's smartphone or tablet PC, or may be a signal input through a microphone inside the vehicle. In addition, the user's request signal may be a signal related to the amount of indoor illuminance of the vehicle, the degree of light blocking, and the light blocking area.

The amount of indoor illuminance optimized for the current indoor information may be a result value that the controller 400 has analyzed a recommended lighting environment optimized according to the position value of the current vehicle and time information.

In the determining, by a controller 400, whether current indoor information and a user's request signal match with each other, when it is determined to match, the controller 400 may maintain the amount of the illuminance of the lighting device, or the light blocking area, of the current state.

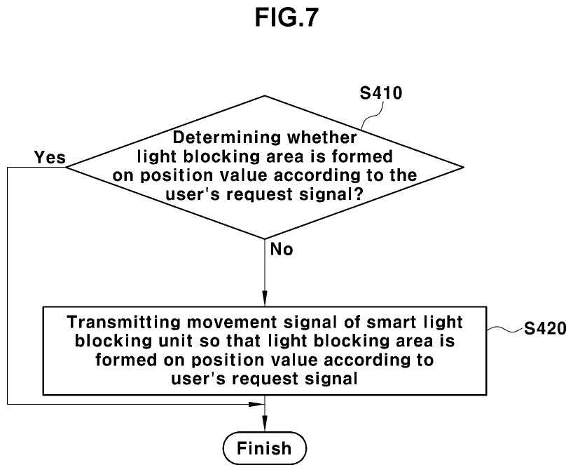

FIG. 7 is a flowchart illustrating adjusting the position value of the light blocking area “A” of a smart light blocking unit 100 in the method for utilizing indoor natural light in a moving space as the embodiment of the present disclosure.

With reference to FIG. 7, the adjusting, by the controller 400, a position value of the light blocking area “A” of the smart light blocking unit 100 may include: determining, by the controller 400, whether the light blocking area “A” is formed according to the user's request signal at S410, and when the lighting is not illuminated to a position value according to a user's request signal, transmitting, by the controller 400, a movement signal of the smart light blocking unit 100 so that a light blocking area “A” is formed on a position value according to the user's request signal at S420.

The determining whether the light blocking area “A” is formed according to the user's request signal by the controller 400 may be determined through whether the light blocking area “A” detected through the camera unit 600 corresponds to the user's request signal. When the controller 400 determines that the light blocking area “A” is not formed at the position value according to the user's request signal, the controller 400 may calculate the amount of movement of the light blocking area “A” formed in the smart light blocking unit 100 in order to implement the light blocking area “A” at a target position.

The controller 400 may calculate a relation of a position of the light source located outside and a position of the light blocking area “A” according to the user's request signal and then control the amount of movement of the light blocking unit configured in at least a portion of the smart light blocking unit 100.

The above detailed description is illustrative of the present disclosure. In addition, the above description shows and describes exemplary embodiments of the present disclosure, and the present disclosure may be used in various other combinations, modifications, and environments. That is, changes or modifications are possible within the scope of the concept of the present disclosure disclosed in the present specification, the scope equivalent to the described disclosure, and/or within the scope of skill or knowledge in the art. The described embodiment describes the best state for implementing the technical idea of the present disclosure, and various changes required in specific application fields and uses of the present disclosure are possible.

Accordingly, the detailed description of the present disclosure is not intended to limit the present disclosure to the disclosed embodiments. Also, the appended claims should be construed as including other embodiments.

1. A structure for utilizing indoor natural light in a moving space, the structure comprising:
a smart light blocking unit located on a vehicle and configured such that transmittance of at least a portion of the smart light blocking unit is able to be controlled;
an indoor camera configured to measure an indoor environment of the vehicle;
a receiver configured to receive a user's request; and
a controller configured to determine an indoor state of the vehicle using the indoor camera, and to set a light blocking area of the smart light blocking unit by receiving the user's request through the receiver.

2. The structure of claim 1, wherein the controller is configured to control the transmittance of at least a portion of the smart light blocking unit to form the requested light blocking area according to a position of an external light source received from the controller.

3. The structure of claim 1, wherein the controller is configured to determine a position of a driver received from the indoor camera, and to control the transmittance of the smart light blocking unit to set the light blocking area in an area corresponding to the driver's view.

4. The structure of claim 1, wherein the smart light blocking unit is positioned in a roof area.

5. The structure of claim 1, further comprising:
a lighting device configured to illuminate light into a vehicle interior.

6. The structure of claim 5, wherein the controller is configured such that, when the indoor camera determines the indoor environment of the vehicle, and when the indoor illuminance of the vehicle is no greater than a reference value, the controller drives the lighting device.

7. The structure of claim 1, wherein the controller is configured to compensate a position of the light blocking area according to a driving state of the vehicle and a positional relation of the light source.

8. A method for utilizing indoor natural light in a moving space, the method comprising:
determining whether current indoor information checking is possible;
when it is determined that the current indoor information checking is possible, determining, by a controller, whether current indoor information and a user's request signal match each other;
when the current indoor information and the user's request signal do not match each other, setting, by the controller, a light blocking area of a smart light blocking unit; and
adjusting, by the controller, a position value of the light blocking area of the smart light blocking unit.

9. The method of claim 8, wherein the determining whether the current indoor information checking is possible comprises:
determining, by the camera unit, whether indoor information detection is possible;
when it is determined that the detection is not possible, operating a lighting device so that the camera unit may detect the indoor information; and
when it is determined that the detection is possible, analyzing the current indoor information, receiving the user's request signal, and analyzing a lighting environment optimized for the current indoor information, by the controller.

10. The method of claim 8, wherein the setting, by the controller, a light blocking area of a smart light blocking unit comprises:
measuring incoming natural light; and
when the incoming natural light is no less than a set value, determining the light blocking area of the smart light blocking unit.

11. The method of claim 8, wherein the adjusting, by the controller, a position value of the light blocking area of the smart light blocking unit comprises:
determining, by the controller, whether the light blocking area is formed on a position value according to the user's request signal; and
when the light blocking area is not formed on the position value according to the user's request signal, transmitting, by the controller, a movement signal of the smart light blocking unit so that the light blocking area is formed on the position value according to the user's request signal.

12. The method of claim 8, wherein, the setting, by the controller, a light blocking area of a smart light blocking unit further comprises:
measuring indoor illuminance of a vehicle, and when the illuminance is no greater than a set value, driving a lighting device, by the controller.
